(19) United States
(12) Patent Application Publication
(10) Pub. No.: US 2022/0253470 A1
(43) Pub. Date: Aug. 11, 2022

(54) MODEL-BASED DOCUMENT SEARCH

(71) Applicant: SparkCognition, Inc., Austin, TX (US)

(72) Inventors: Jaidev Amrite, Austin, TX (US); Erik Skiles, Manor, TX (US)

(21) Appl. No.: 17/557,899

(22) Filed: Dec. 21, 2021

Related U.S. Application Data
(60) Provisional application No. 63/146,227, filed on Feb. 5, 2021.

(51) Int. Cl. G06F 16/332; G06F 16/33; G06F 40/30

(52) U.S. Cl. CPC G06F 16/3326; G06F 40/30; G06F 16/3334

(57) ABSTRACT

A device includes a processor configured to receive first user input indicating keywords of a search and to select matching document segments and exploratory document segments from a document set. Each document segment of the matching document segments is selected in response to determining that the document segment matches at least one of the keywords. Each document segment of the exploratory document segments does not match any of the keywords. The processor is further configured to display first search results indicating at least one of the matching document segments and at least one of the exploratory document segments, and to receive second user input indicating whether the first search results are relevant to the search. The processor is configured to generate a search model based on the second user input, and to generate second search results based at least in part on applying the search model to the document set.

### CROSS-REFERENCE TO RELATED APPLICATIONS

The present application claims priority from U.S. Provisional Patent Application No. 63/146,227 entitled “MODEL-BASED DOCUMENT SEARCH,” filed Feb. 5, 2021, the contents of which are incorporated herein by reference in their entirety.

### FIELD

The present disclosure is generally related to model-based document search.

### BACKGROUND

Data analysis improves with greater coverage of relevant information. As more and more data (e.g., big data) becomes available, searching for relevant information from large data sets becomes a complex problem. With rapidly changing conditions, timely identification of the relevant information can be critical for useful analysis.

### SUMMARY

Particular implementations of systems and methods to perform a model-based document search are described herein. A search engine generates search results indicating document segments of a set of documents. A first subset of the search results is based on one or more keywords of a search. A second subset of the search results is independent of the one or more keywords. The search results are displayed to a user to indicate whether the document segments of the search results are relevant to the search (e.g., of interest to the user). The search engine generates a search model based on user input indicating first document segments of the search results are relevant to the search and second document segments of the search results are not relevant to the search. The search engine generates the search model to, in a subsequent performance of the search, give more preference to document segments that match the first document segments and give less preference to document segments that match the second document segments.

In a particular aspect, a device includes a processor configured to receive first user input indicating one or more keywords of a search and to select matching document segments from a set of documents. Each document segment of the matching document segments is selected in response to determining that the document segment matches at least one of the one or more keywords. The processor is also configured to select exploratory document segments from the set of documents. Each document segment of the exploratory document segments does not match any of the one or more keywords. The processor is further configured to provide first search results to a display device. The first search results indicate at least one of the matching document segments and at least one of the exploratory document segments. The processor is also configured to receive second user input indicating whether one or more of the first search results are relevant to the search. The processor is further configured to generate a search model based on the second user input, and to generate second search results based at least in part on applying the search model to the set of documents.

In another particular aspect, a method includes receiving, at a device, first user input indicating one or more keywords of a search. The method also includes selecting, at the device, matching document segments from a set of documents. Each document segment of the matching document segments is selected in response to determining that the document segment matches at least one of the one or more keywords. The method further includes selecting, at the device, exploratory document segments from the set of documents. Each document segment of the exploratory document segments does not match any of the one or more keywords. The method also includes providing, at the device, first search results to a display device. The first search results indicate at least one of the matching document segments and at least one of the exploratory document segments. The method further includes receiving, at the device, second user input indicating whether one or more of the first search results are relevant to the search. The method also includes generating, at the device, a search model based on the second user input. The method further includes generating, at the device, second search results based at least in part on applying the search model to the set of documents.

In another particular aspect, a computer-readable storage device stores instructions that, when executed by one or more processors, cause the processors to receive first user input indicating one or more keywords of a search. The instructions, when executed by the processors, also cause the processors to select matching document segments from a set of documents. Each document segment of the matching document segments is selected in response to determining that the document segment matches at least one of the one or more keywords. The instructions, when executed by the processors, further cause the processors to select exploratory document segments from the set of documents. Each document segment of the exploratory document segments does not match any of the one or more keywords. The instructions, when executed by the processors, also cause the processors to provide first search results to a display device. The first search results indicate at least one of the matching document segments and at least one of the exploratory document segments. The instructions, when executed by the processors, further cause the processors to receive second user input indicating whether one or more of the first search results are relevant to the search. The instructions, when executed by the processors, also cause the processors to generate a search model based on the second user input. The instructions, when executed by the processors, further cause the processors to generate second search results based at least in part on applying the search model to the set of documents.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a block diagram that illustrates an example of a system configured to perform a model-based document search;

FIG. 2 is a diagram that illustrates an example of a document search that may be performed by the system of FIG. 1;

FIG. 3 is a diagram that illustrates an example of a graphical user interface (GUI) that may be generated by the system of FIG. 1;

FIG. 4 is a diagram that illustrates an example of a model-based document search that may be performed by the system of FIG. 1;

FIG. 5 is a diagram that illustrates an example of a GUI that may be generated by the system of FIG. 1; and

FIG. 6 is a flow chart of an example of a method of performing a model-based document search.

### DETAILED DESCRIPTION

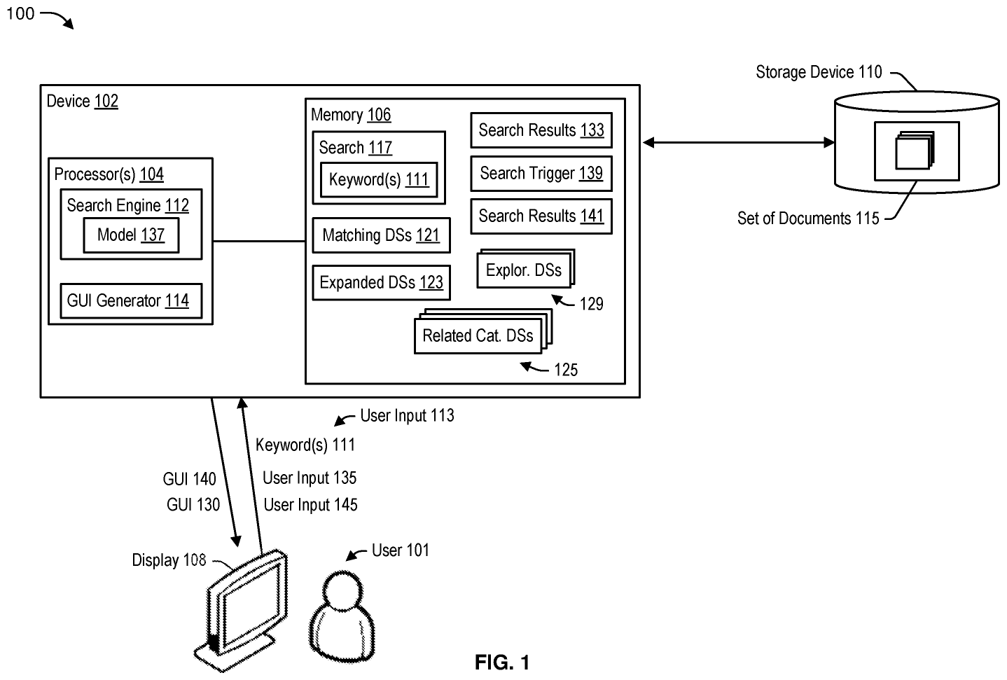

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 104 in FIG. 1), which indicates that in some implementations the device 102 includes a single processor 104 and in other implementations the device 102 includes multiple processors 104.

It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically or communicatively coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical or other signals (e.g., digital signals or analog signals) directly or indirectly, such as via one or more wires, buses, wired or wireless networks, etc. As used herein, “directly coupled” may include two devices that are coupled (e.g., communicatively coupled, electrically coupled, or physically coupled) without intervening components.

Referring to FIG. 1, a system operable to perform a model-based document search is shown and generally designated 100. The system 100 includes a device 102 coupled to a storage device 110 and to a display device 108. In a particular aspect, each of the storage device 110 and the display device 108 is external to the device 102. In an alternative aspect, the storage device 110, the display device 108, or both, are integrated into the device 102. The device 102 includes one or more processors 104 coupled to a memory 106. The one or more processors 104 includes a search engine 112, a graphical user interface (GUI) generator 114, or both.

The storage device 110 is configured to store a set of documents 115. In a particular aspect, the set of documents 115 is associated with a particular domain, such as a topic, a location, a time range, an entity, an event, a document source, a language, or a combination thereof. In a particular aspect, the set of documents 115 may change over time. For example, one or more documents may be added or removed from the set of documents 115.

The GUI generator 114 is configured generate one or more GUIs. The search engine 112 is configured to generate search results 133 from the set of documents 115 based on one or more keywords 111. Each of the search results 133 indicates at least a document segment of a document of the set of documents 115. In a particular aspect, a document segment includes one or more sentences. The search engine 112 is configured to, in response to receiving a user input 135 indicating whether one or more of the search results 133 are relevant, generate a model 137 based on the user input 135. For example, the model 137 is generated to, in a subsequent performance of a search, give more preference to document segments that match relevant document segments of the search results 133 and give less preference to document segments that match not relevant documents segments of the search results 133. The search engine 112 is configured to, in response to determining that a search trigger 139 is satisfied, generate search results 141 by applying the model 137 to the set of documents 115.

During operation, the GUI generator 114 generates a GUI 130 and provides the GUI 130 to the display device 108. For example, the GUI generator 114 generates the GUI 130 in response to a user input from a user 101 to activate a search application associated with the search engine 112. The user 101 provides, via the GUI 130, a user input 113 indicating one or more keywords 111 (e.g., “Queen” and “British”).

The search engine 112, in response to receiving the user input 113 indicating the one or more keywords 111 of a search 117, creates the search 117 in the memory 106 and associates the search 117 with the set of documents 115 and the one or more keywords 111. In a particular aspect, the search engine 112 is associated with a single set of documents, e.g., the search engine 112 is designed to perform searches in the set of documents 115. In an alternative aspect, the search engine 112 is capable of performing searches in multiple sets of documents, and the multiple sets of documents include the set of documents 115 associated with a particular domain, one or more additional sets of documents associated with one or more additional domains, or a combination thereof. In this aspect, the user input 113 indicates the particular domain (e.g., “current events”), and the search engine 112 associates the search 117 with the set of documents 115 in response to determining that the set of documents 115 is associated with (e.g., included in) the particular domain.

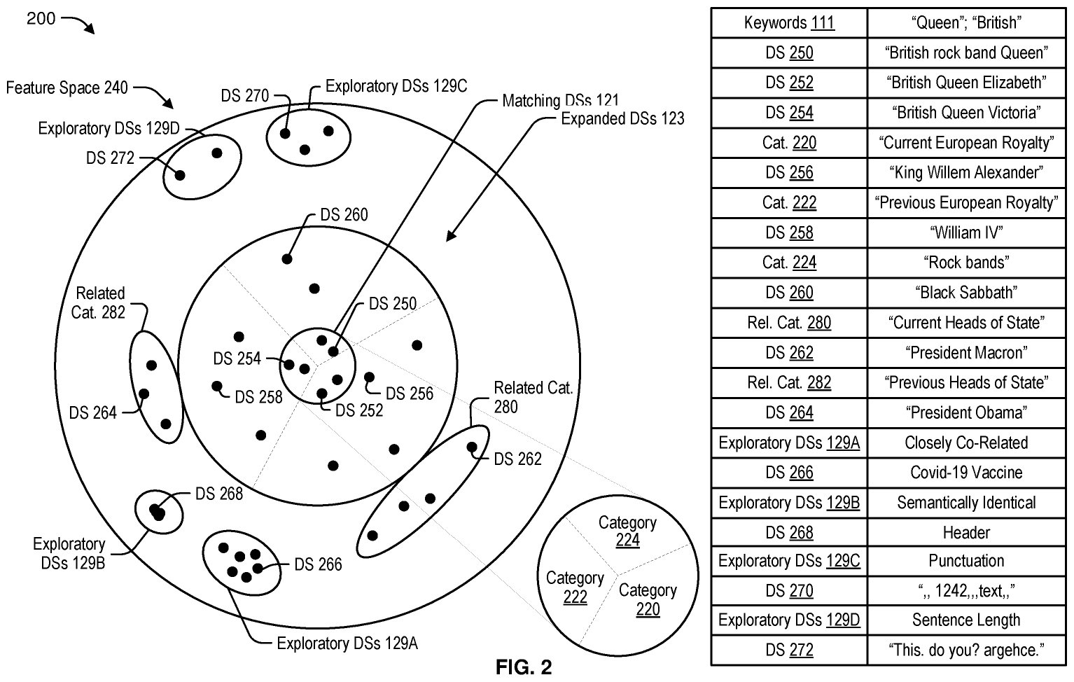

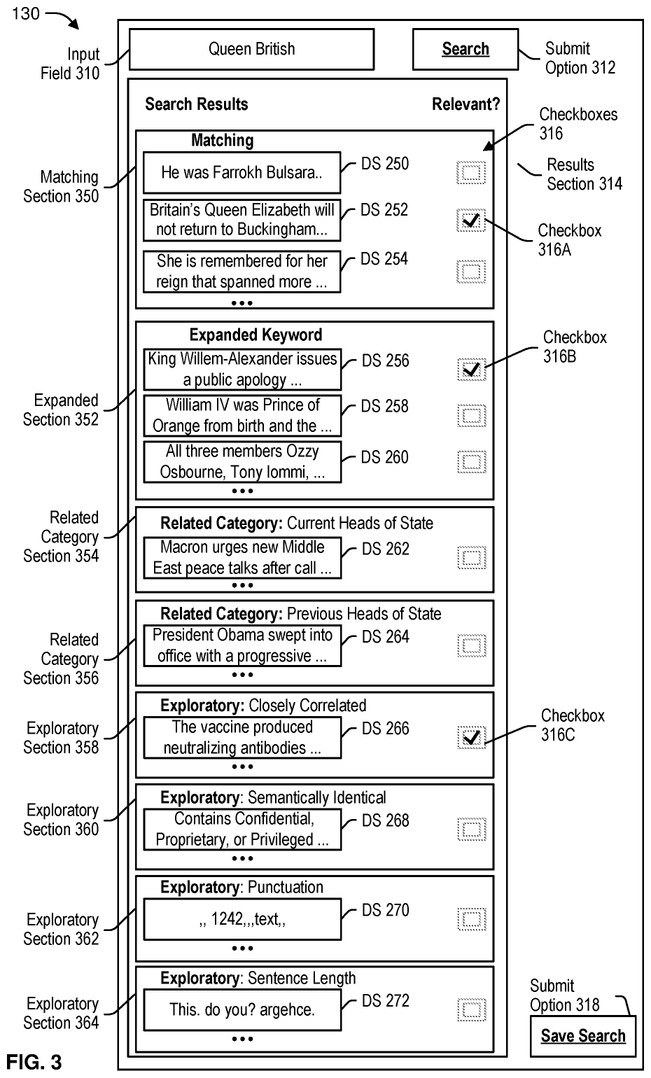

The search engine 112 performs the search 117 (e.g., a model-independent search) in response to receiving the user input 113, as further described with reference to FIGS. 2-3. For example, the search engine 112 selects one or more matching document segments 121 from the set of documents 115. The search engine 112 selects each document segment of the one or more matching document segments 121 in response to determining that the document segment matches at least one of the one or more keywords 111 (e.g., “Queen” and “British”), as further described with reference to FIG. 2. For example, the search engine 112 selects a document segment from a document of the set of documents 115 in response to determining that the document segment (e.g., “Britain's Queen Elizabeth will not return to Buckingham Palace.”) matches at least one of the one or more keywords 111 (e.g., “Queen” and “British”).

In a particular aspect, the search engine 112, in response to determining that the one or more matching document segments 121 are included in one or more first categories (e.g., “Current European Royalty”), selects one or more related category document segments 125 from the set of documents 115 that are associated with one or more second categories (e.g., “Current Heads of State”) that are related to the one or more first categories, as further described with reference to FIG. 2. For example, the search engine 112 selects a document segment from a document of the set of documents 115 in response to determining that the document segment (e.g., “Macron urges new Middle East peace talks after call.”) matches (e.g., includes content associated with) one or more second categories (e.g., “Current Heads of State”) that are related to the one or more first categories (e.g., “Current European Royalty”).

In a particular aspect, the search engine 112 selects one or more expanded document segments 123 from the set of documents 115. The search engine 112 selects each document segment of the one or more expanded document segments 123 in response to determining that the document segment matches one or more second keywords that are semantically similar to the one or more keywords 111, as further described with reference to FIG. 2. For example, the search engine 112 selects a document segment from a document of the set of documents 115 in response to determining that the document segment (e.g., “King William-Alexander issues a public apology.”) matches one or more second keywords (e.g., “Royal” and “Europe”) that are related to the one or more keywords 111 (e.g., “Queen” and “British”).

In a particular aspect, the search engine 112 selects one or more exploratory document segments 129 from the set of documents 115 in response to determining that a correlation among the one or more exploratory document segments 129 is greater than a threshold, as further described with respect to FIG. 2. Each document segment of the one or more exploratory document segments 129 does not match any of the one or more keywords 111.

In some examples, a first subset of the one or more exploratory document segments 129 corresponds to a topic of interest (e.g., a trending topic) that is covered in a large number of related documents that could be relevant to the user 101 (e.g., relevant to the search 117) even though each document segment of the first subset does not match any of the one or more keywords 111. In a particular implementation, the search engine 112 selects the first subset of the one or more exploratory document segments 129 from the set of documents 115 in response to determining that a correlation among the first subset is greater than a correlation threshold, that the first subset is from a count of documents (e.g., 20 documents) that is greater than a document count threshold, that the documents are generated within a threshold time range (e.g., within the past two days, the past 5 hours, or the past half an hour), or a combination thereof.

In a particular aspect, the search engine 112 selects one or more subsets of the one or more exploratory document segments 129 that are likely to be of no interest to the user 101 (e.g., not relevant to the search 117). For example, the search engine 112 selects a second subset of the one or more exploratory document segments 129 that appear to correspond to templates, headers, footers, etc. To illustrate, the search engine 112 selects the second subset in response to determining that each document segment of the second subset is semantically identical to other document segments of the second subset. In a particular example, the search engine 112 selects a third subset of the one or more exploratory document segments 129 that appear to correspond to unintelligible content (e.g., including format conversion artifacts, non-human-readable format content, etc.). To illustrate, the search engine 112 selects the third subset in response to determining that each document segment of the third subset includes an average count of punctuation marks per sentence that is greater than a punctuation threshold, that each document segment of the third subset includes an average sentence length that is less than a length threshold, or both.

The GUI generator 114 generates (or updates) the GUI 130 to include search results 133 that indicate at least one of the one or more matching document segments 121, at least one of the one or more expanded document segments 123, at least one of the one or more related category document segments 125, at least one of the one or more exploratory document segments 129, or a combination thereof, as further described with reference to FIG. 3. The GUI generator 114 provides the GUI 130 to the display device 108. The user 101 provides, via the GUI 130, user input 135 indicating whether one or more of the search results 133 are relevant to the search 117. For example, the user input 135 indicates which document segments (if any) indicated by the search results 133 are relevant to the search 117 (e.g., of interest to the user 101) and which document segments (if any) indicated by the search results 133 are not relevant to the search 117 (e.g., not of interest to the user 101).

The search engine 112 generates a model 137 (e.g., a search model) based on the user input 135. For example, the search engine 112, in response to determining that the user input 135 indicates that a first subset of the document segments indicated by the search results 133 is relevant to the search 117, generates (or updates) the model 137 to give more preference, in a subsequent performance of the search 117, to document segments that match the first subset. In a particular aspect, a first document segment matches a second document segment if a semantic similarity between the first document segment and the second document segment is greater than a threshold, the first document segment includes at least a threshold count of first keywords that are related to second keywords included in the second document segment, or both. In a particular example, the search engine 112, in response to determining that the user input 135 indicates that a second subset of the document segments indicated by the search results 133 is not relevant to the search 117, generates (or updates) the model 137 to give less preference, in a subsequent performance of the search 117, to document segments that match the second subset. In a particular aspect, the model 137 includes an artificial neural network. In a particular aspect, the model 137 is trained using an artificial neural network training technique. For example, the search engine 112 provides features of the document segments indicated by the search results 133 to generate model-predicted relevance of the document segments, and updates the model 137 based on a comparison of the model-predicted relevance and the relevance of the document segments indicated by the user input 135. To illustrate, the search engine 112 provides features of a particular document segment indicated by the search results 133 as input to the model 137 and the model 137 generates a particular output indicating a model-predicted relevance of the particular document segment. The search engine 112 updates adaptive parameters (e.g., biases and weights) of the model 137 based on a comparison of the model-predicted relevance and the relevance of the particular document segment indicated in the user input 135.

The search engine 112, subsequent to generating (or updating) the model 137, determines whether a search trigger 139 is satisfied. The search trigger 139 is based on default data, user input, configuration data, data received from another device, or a combination thereof. In a particular example, the user input 113, the user input 135, or both, indicate the search trigger 139. To illustrate, the search engine 112, in response to determining that the user input 113, the user input 135, or both, indicate the search trigger 139, associates the search trigger 139 with the search 117, the model 137, or both, in the memory 106. To illustrate, the user 101 selects an option of the GUI 130, the GUI 140, or both, to indicate the search trigger 139. In a particular aspect, the search engine 112 determines that the search trigger 139 is satisfied in response to determining that a particular time has elapsed since a previous performance of the search 117, that a threshold count of documents have been added to the set of documents 115 since the previous performance of the search 117, that a request is received to perform the search 117, or a combination thereof.

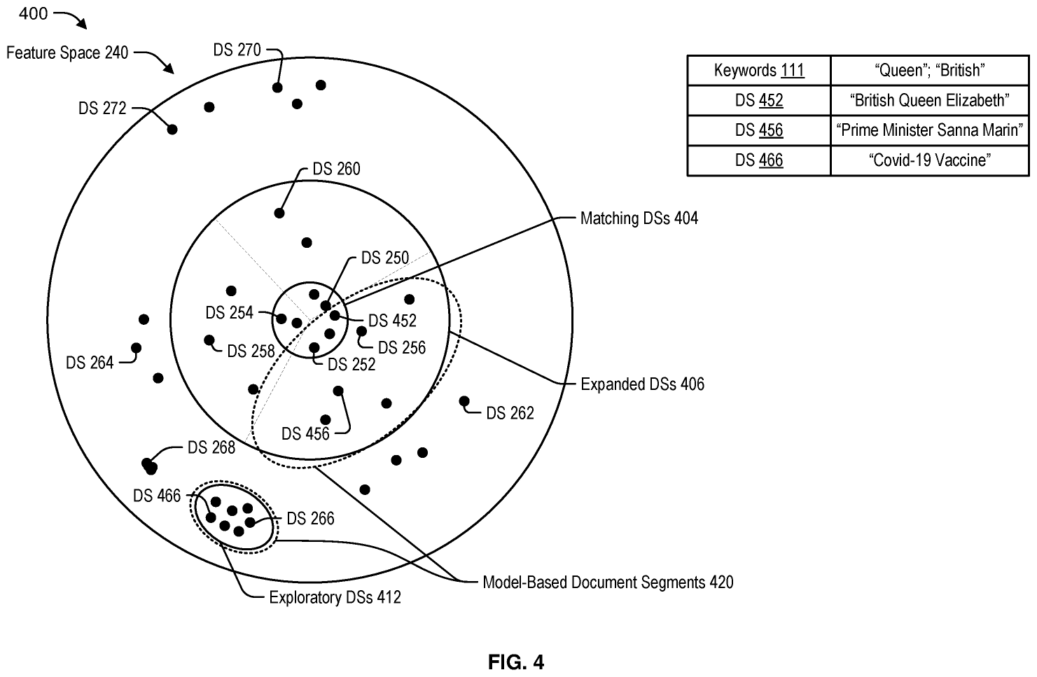

The search engine 112, in response to determining that the search trigger 139 is satisfied, performs the search 117 by applying the model 137 to the set of documents 115 to generate search results 141, as further described with reference to FIG. 4. In a particular aspect, one or more documents are added or removed from the set of documents 115 subsequent to generating the search results 133 (or generating the model 137) and prior to generating the search results 141. In a particular implementation, the search engine 112, in response to determining that the search trigger 139 is satisfied, performs the search 117 by applying the model 137 to any additional documents that are added to the set of documents 115 subsequent to a previous performance of the search 117 so that only additions are analyzed instead of analyzing the entire set of documents 115 at each performance of the search 117. The search engine 112 generates the search results 141 by applying the model 137 to the set of documents 115 (or the additions to the set of documents 115). In a particular example, the search results 141 indicate at least one document segment of the one or more of the additional documents that are added to the set of documents 115 subsequent to a previous performance of the search 117, subsequent to generating the model 137, or both.

In a particular aspect, the model 137 gives preference to document segments that match the document segments that the user 101 previously identified as relevant to the search 117. For example, the search results 141 include document segments that match the document segments that were previously identified as relevant to the search 117 and exclude document segments that match document segments that were previously identified as not relevant to the search 117.

In a particular implementation, the search engine 112 generates a first subset of the search results 141 based on the model 137, as described above, and generates a second subset of the search results 141 independently of the model 137. For example, the search engine 112 selects second matching document segments, second related category document segments, second expanded document segments, second exploratory document segments, or a combination thereof, from the set of documents 115 (or additions to the set of documents 115) as the second subset of the search results 141.

In a particular aspect, the search engine 112 selects each document segment of the second matching document segments in response to determining that the document segment matches at least one of the one or more keywords 111, that the document segment is included in an additional document added to the set of documents 115, or both. In a particular aspect, the search engine 112 selects each related category document segment in response to determining that the second matching document segments are included in one or more first categories, that the related category document segment includes content associated with one or more second categories, and that each of the second categories is related to at least one of the one or more first categories.

In a particular aspect, the search engine 112 selects each document segment of the second expanded document segments in response to determining that the document segment matches one or more second keywords that are semantically similar to the one or more keywords 111. In a particular aspect, the search engine 112 selects the second exploratory document segments in response to determining that a correlation between the second exploratory document segments is greater than a threshold. Each document segment of the second exploratory document segments does not match the one or more keywords 111.

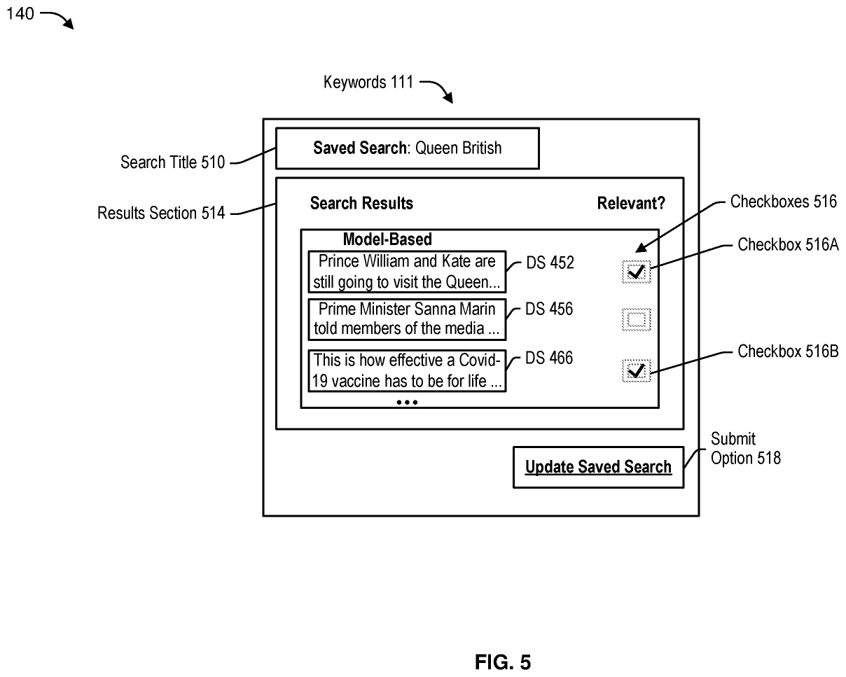

In a particular aspect, the GUI generator 114 generates a GUI 140 including the search results 141, as further described with reference to FIG. 5, and provides the GUI 140 to the display device 108. In a particular aspect, the user 101 provides, via the GUI 140, user input 145 indicating whether one or more of the search results 141 are relevant to the search 117. For example, the user input 145 indicates which document segments (if any) indicated by the search results 141 are relevant to the search 117 and which document segments (if any) indicated by the search results 141 are not relevant to the search 117. In a particular aspect, the search engine 112 updates the model 137 based on the user input 145. For example, the search engine 112 updates the model 137 to, in a subsequent performance of the search 117, give more preference to document segments that match relevant document segments indicated by the user input 145 and less preference to document segments indicated as not relevant by the user input 145. The model 137 can thus be iteratively trained to identify document segments that are relevant to the user 101. In a particular aspect, the model 137 can change over time as the user preferences change.

In a particular implementation, the model 137 can be used to perform a search based on related keywords. For example, the search engine 112 performs a search using the model 137 (or a copy of the model 137) in response to receiving user input indicating one or more second keywords and determining that the second keywords are related to (e.g., synonyms of or associated with the same topic, time, person, entity, event, etc. as) the one or more keywords 111. The search engine 112 creates a particular search that is associated with the one or more second keywords and associates the model 137 (or the copy of the model 137) with the second search. The model 137 can be used to “bootstrap” a new search model for related keywords instead of building the new search model from scratch.

In a particular implementation, the model 137 can be used to perform a search on a different set of documents. For example, the search engine 112 performs a search using the model 137 (or a copy of the model 137) in response to receiving user input indicating a second set of documents and the one or more keywords 111. In a particular aspect, the second set of documents is associated with a second domain (e.g., a topic, a location, a time range, an entity, an event, a document source, a language, or a combination thereof) that is different from a first domain associated with the set of documents 115. To illustrate, the first domain is related to a first topic (e.g., “social news”), a first document source (e.g., CNN® (a registered trademark of Cable News Network, Inc., Georgia) new stories), a first language (e.g., English), or a combination thereof, and the second domain is related to a second topic (e.g., “financial news”), a second document source (e.g., The Wall Street Journal® (a registered trademark of Dow Jones, L.P., New York) news stories), a second language (e.g., Italian), or a combination thereof. The search engine 112 creates a particular search that is associated with the second set of documents and associates the model 137 (or the copy of the model 137) with the particular search. The model 137 can be used to “bootstrap” a new search model for other document sets instead of building the new search model from scratch.

The system 100 thus enables training of the model 137 to identify document segments that are relevant to the user 101. Generating the model 137 at least partially based on relevant document segments that are identified independently of the one or more keywords 111 enables the model 137 to generate search results that provide a wide coverage of relevant documents. In a particular aspect, as the model 137 is updated with repeated performance of the search 117, the performance of the model 137 improves in identifying search results that are increasingly relevant to the search 117.

Referring to FIG. 2, a diagram illustrating aspects of a document search is shown and generally designated 200. In a particular aspect, the document search is performed by the search engine 112, the one or more processors 104, the device 102, the system 100 of FIG. 1, or a combination thereof. For example, the search engine 112 performs the document search based on the one or more keywords 111 and a feature space 240 (e.g., a vector space) representing the set of documents 115. To illustrate, if a first distance between a representation of a first document segment and a representation of a second document segment in the feature space 240 is less than a second distance between the representation of the first document segment and a representation of a third document segment, the first document segment is a closer match of (e.g., semantically closer to) the second document segment than of the third document segment.

In a particular aspect, the document search includes a model-independent search performed by the search engine 112 in response to receiving the one or more keywords 111 (e.g., “Queen” and “British”), as described with reference to FIG. 1. For example, the search engine 112 performs the document search in response to receiving the one or more keywords 111 and determining that the one or more keywords 111 are not associated with any pre-existing model.

During the document search, the search engine 112 identifies keyword-related subspaces of the feature space 240 based on the one or more keywords 111 and identifies keyword-independent subspaces of the feature space 240 independently of the one or more keywords 111. Document segments in a particular subspace have commonalities, e.g., semantic similarities, similar categories, similar topics, similar sources, or other similar feature values. The search engine 112 generates search results 133 indicating at least one of the document segments included in the keyword-related subspaces, at least one of the document segments included in the keyword-independent subspaces, or a combination thereof.

In a particular aspect, the search engine 112 selects a first keyword-related subspace that matches the one or more keywords 111 (e.g., “British” and “Queen”). The first keyword-related subspace indicates a document segment 250 that includes first words (e.g., “British rock band Queen”) that match at least one of the one or more keywords 111 (e.g., “Queen” and “British”), a document segment 252 that includes second words (e.g., “British Queen Elizabeth”) that match at least one of the one or more keywords 111, a document segment 254 that includes third words (e.g., “British Queen Victoria”) that match at least one of the one or more keywords 111, one or more additional document segments that include words that match at least one of the one or more keywords 111, or a combination thereof. The search engine 112 selects the document segment 250 (e.g., about “British rock band Queen”), the document segment 252 (e.g., about “British Queen Elizabeth”), the document segment 254 (e.g., about “British Queen Victoria”), the one or more additional document segments of the first keyword-related subspace as the one or more matching document segments 121.

In a particular aspect, the search engine 112 selects one or more keyword-related subspaces that match particular keywords that, although not the same as the one or more keywords 111, are semantically similar (e.g., have a greater than threshold semantic similarity) to the one or more keywords 111 (e.g., “British” and “Queen”). In a particular implementation, a first keyword (e.g., “European”) is semantically similar to a second keyword if a distance between the first keyword and the second keyword in the feature space 240 is less than a threshold distance. In a particular implementation, the threshold distance is based on a user input, a configuration setting, default data, or a combination thereof.

In a particular example, the search engine 112 selects a second keyword-related subspace that matches first similar keywords (e.g., “European” and “Royalty”) that are semantically similar to the one or more keywords 111 (e.g., “British” and “Queen”). In a particular aspect, the second keyword-related subspace indicates a document segment 256 that includes first words (e.g., “King Willem Alexander”) that match the first similar keywords (e.g., “European” and “Royalty”), one or more additional document segments, or a combination thereof. In another example, the search engine 112 selects a third keyword-related subspace that matches second similar keywords (e.g., “British” and “Royalty”) that are semantically similar to the one or more keywords 111 (e.g., “British” and “Queen”). In a particular aspect, the third keyword-related subspace indicates a document segment 258 that includes second words (e.g., “William IV”) that match the second similar keywords (e.g., “British” and “Royalty”), one or more additional document segments, or a combination thereof. In a particular example, the search engine 112 selects a fourth keyword-related subspace that matches third similar keywords (e.g., “British” and “Rock Band”) that are semantically similar to the one or more keywords 111 (e.g., “British” and “Queen”). In a particular aspect, the fourth keyword-related subspace indicates a document segment 260 that includes third words (e.g., “Black Sabbath”) that match the third similar keywords (e.g., “British” and “Rock Band”), one or more additional document segments, or a combination thereof. The search engine 112 selects the document segments of the second keyword-related subspace, the third keyword-related subspace, the fourth keyword-related subspace, or a combination thereof, as the one or more expanded document segments 123. The one or more expanded document segments 123 match semantically similar keywords to the one or more keywords 111, and thus at least some of the expanded documents segments are probably relevant to the search 117. It should be understood that the one or more expanded document segments 123 including document segments indicated by three keyword-related subspaces are provided as an illustrative example. In other examples, the one or more expanded document segments 123 can include document segments indicated by fewer than three or more than three keyword-related subspaces.

In a particular aspect, each of the one or more matching document segments 121 is included in one or more first categories, such as a category 220, a category 222, a category 224, one or more additional categories, or a combination thereof. For example, the document segment 250, that includes the first words (e.g., “British rock band Queen”), is included in a subspace related to the category 224 (e.g., “British Rock Bands”). The document segment 252, that includes the second words (e.g., “British Queen Elizabeth”), is included in a subspace related to the category 220 (e.g., “Current European Royalty”). The document segment 254, that includes third words (e.g., “British Queen Victoria”), is included in a subspace related to the category 222 (e.g., “Previous European Royalty”). In a particular aspect, a subspace related to a particular category can include any count (e.g., greater than or equal to 1) of the one or more matching document segments 121.

In a particular aspect, the search engine 112 selects one or more keyword-related subspaces that match one or more second categories that are related to the first categories. For example, the search engine 112 determines that a related category 280 (e.g., “Current Heads of State”) is related to the category 220 (e.g., “Current European Royalty”). The search engine 112 selects a fifth keyword-related subspace that matches the related category 280 (e.g., “Current Heads of State”). The fifth keyword-related subspace includes a representation of a document segment 262 that includes content (e.g., “President Macron”) included in the category 280, one or more additional document segments, or a combination thereof. As another example, the search engine 112 determines that a related category 282 (e.g., “Previous Heads of State) is related to the category 222 (e.g., “Previous European Royalty”). The search engine 112 selects a sixth keyword-related subspace that matches the related category 282 (e.g., “Previous Heads of State). The sixth keyword-related subspace includes a representation of a document segment 264 that includes content (e.g., “President Obama”) included in the category 282, one or more additional document segments, or a combination thereof. The search engine 112 selects the document segments indicated by the fifth keyword-related subspace, the sixth keyword-related subspace, or a combination thereof, as the one or more related category document segments 125. The one or more related category document segments 125 include document segments that are included in categories that are related to the first categories and thus are possibly relevant to the search 117. It should be understood that the one or more related category document segments 125 including document segments indicated by two keyword-related subspaces are provided as an illustrative example. In other examples, the one or more related category document segments 125 can include document segments indicated by fewer than two or more than two keyword-related subspaces.

In a particular aspect, the search engine 112 selects one or more keyword-independent subspaces in response to determining that a correlation among a plurality of document segments representations included in the keyword-independent spaces is greater than a threshold. In a particular aspect, each document segment indicated by the keyword-independent subspaces does not match any of the one or more keywords 111 (e.g., “British” and “Queen”). For example, the search engine 112 selects a first keyword-independent subspace in response to determining that a correlation among one or more exploratory document segments 129A indicated by the first keyword-independent subspace is greater than a correlation threshold, that a count of the one or more exploratory document segments 129A is greater than a count threshold, that each of the one or more exploratory document segments 129A is generated within a particular time range (e.g., within the previous one week, one day, one hour, etc.), or a combination thereof. In a particular aspect, the one or more exploratory document segments 129A are of interest (e.g., trending) at the time of the search 117 in the domain associated with the set of documents 115. For example, the search engine 112, in response to determining that a correlation between the document segments (e.g., including a document segment 266 that includes particular words (e.g., “Covid-19 Vaccine”)) of the first keyword-independent subspace is greater than a correlation threshold, that a count of the document segments indicated by the first keyword-independent subspace is greater than a count threshold, that each of the document segments of the first keyword-independent subspace is from a document generated within a particular time range (e.g., previous one week), or a combination thereof, selects the document segments (e.g., the document segment 266 and one or more additional document segments) of the first keyword-independent subspace as the one or more exploratory document segments 129A. In a particular example, although the one or more exploratory document segments 129A do not include any of the one or more keywords 111, the one or more exploratory document segments 129A include a large count (e.g., at least a threshold count) of exploratory document segments that are correlated and thus are possibly relevant to the domain (e.g., “international news”) associated with the set of documents 115 and possibly relevant to the search 117.

In a particular example, the search engine 112 selects a second keyword-independent subspace in response to determining that each document segment of exploratory document segments 129B indicated by the second keyword-independent subspace is semantically identical to (or semantically overlapping) other document segments of the one or more exploratory document segments 129B. In a particular aspect, the one or more exploratory document segments 129B (e.g., a document segment 268, one or more additional document segments, or a combination thereof) correspond to non-interesting information, such as headers, footers, templates, stock language, etc., that is unlikely to be relevant to the search 117.

In a particular example, the search engine 112 selects a third keyword-independent subspace in response to determining that each document segment of one or more exploratory document segments 129C indicated by the third keyword-independent subspace includes an average count of punctuation marks per sentence (or per threshold character count) that is greater than a punctuation threshold. In a particular example, the search engine 112 selects a fourth keyword-independent subspace in response to determining that each document segment of one or more exploratory document segments 129D indicated by the fourth keyword-independent subspace includes an average sentence length that is less than a length threshold. In a particular aspect, the one or more exploratory document segments 129C includes a document segment 270 (e.g., “ . . . 1242 . . text. . . ”), one or more additional document segments, or a combination thereof. In a particular aspect, the one or more exploratory document segments 129D includes a document segment 272 (e.g., “This. do you? argehce.”), one or more additional document segments, or a combination thereof. In a particular implementation, the one or more exploratory document segments 129C, the one or more exploratory document segments 129D, or a combination thereof, correspond to unintelligible content (e.g., including format conversion artifacts, non-human-readable format content, etc.) that is unlikely to be relevant to the search 117.

The search engine 112 generates the search results 133 indicating at least one of the one or more matching document segments 121, at least one of the one or more expanded document segments 123, at least one of the document segments included in the related category 280, at least one of the document segments included in the related category 282, at least one of the one or more exploratory document segments 129A, at least one of the one or more exploratory document segments 129B, at least one of the one or more exploratory document segments 129C, at least one of the one or more exploratory document segments 129D, or a combination thereof.

The document search thus generates the search results 133 indicating document segments that are likely to be relevant to the search 117 as well as document segments that are unlikely to be relevant to the search 117. The search results 133 can include document segments selected based on the one or more keywords 111 as well as document segments selected independently of the one or more keywords 111.

Referring to FIG. 3, an example of the GUI 130 is shown. In a particular aspect, the GUI 130 is generated by the GUI generator 114, the one or more processors 104, the device 102, the system 100 of FIG. 1, or a combination thereof.

In a particular example, the GUI generator 114, in response to a user input activating a search application, generates the GUI 130 including an input field 310 and a submit option 312, and provides the GUI 130 to the display device 108 of FIG. 1. The user 101 of FIG. 1 provides the one or more keywords 111 in the input field 310 and selects the submit option 312. The search engine 112 performs the document search of FIG. 1 based on the one or more keywords 111 to generate the search results 133, as described with reference to FIG. 2.

The GUI generator 114 generates (or updates) the GUI 130 to include a results section 314 indicating the search results 133, and a submit option 318 to save the search 117. For example, the GUI 130 includes a matching section 350 that indicates the one or more matching document segments 121, such as the document segment 250, the document segment 252, the document segment 254, one or more additional matching document segments, or a combination thereof. In a particular aspect, the GUI 130 includes an expanded section 352 that indicates the one or more expanded document segments 123, such as the document segment 256, the document segment 258, the document segment 260, one or more additional expanded document segments, or a combination thereof.

In a particular aspect, the GUI 130 includes one or more related category sections (e.g., a related category section 354, a related category section 356, one or more additional related category sections, or a combination thereof) indicating the one or more related category document segments 125. For example, the related category section 354 indicates the document segment 262 included in the related category 280 of FIG. 2. As another example, the related category section 356 indicates the document segment 264 included in the related category 282 of FIG. 2.

In a particular aspect, the GUI 130 includes one or more exploratory sections that indicate the one or more exploratory document segments 129. For example, the GUI 130 includes an exploratory section 358, an exploratory section 360, an exploratory section 362, and an exploratory section 364 that indicate the one or more exploratory document segments 129A, the one or more exploratory document segments 129B, the one or more exploratory document segments 129C, and the one or more exploratory document segments 129D of FIG. 2, respectively.

In a particular aspect, the GUI 130 includes one or more checkboxes 316 that are selectable by the user 101 to indicate whether a corresponding document segment is relevant to the search 117. In a particular aspect, a selected checkbox indicates that a corresponding document segment is relevant to the search 117. Alternatively, an unselected checkbox indicates that a corresponding document segment is not relevant to the search 117. It should be understood that checkboxes are provided as an illustrative example of an input to indicate relevance or non-relevance of document segments. In other implementations, other types of inputs can be used to indicate various degrees of relevance.

In a particular aspect, the user 101 selects a checkbox 316A, a checkbox 316B, and a checkbox 316C to indicate that the document segment 252 (e.g., “Britain's Queen Elizabeth will not return to Buckingham.”), the document segment 256 (e.g., “King Willem-Alexander issues a public apology . . . ”), and the document segment 266 (e.g., “The vaccine produced neutralizing antibodies . . . ”), respectively, are relevant to the search 117. The user 101 selects the submit option 318 to save the search 117 and the search engine 112, in response to the user selection of the submit option 318, receives a user input 135 indicating the user selections of the checkboxes 316.

The search engine 112 generates the model 137 based on the user input 135 in response to receiving the selection of the submit option 318. For example, the search engine 112 generates the model 137, as described with reference to FIG. 1, to give more preference to document segments that match the document segment 252 (e.g., “Britain's Queen Elizabeth will not return to Buckingham.”), the document segment 256 (e.g., “King Willem-Alexander issues a public apology . . . ”), and the document segment 266 (e.g., “The vaccine produced neutralizing antibodies . . . ”). To illustrate, the search engine 112 generates the model 137 to give more preference to document segments indicated in the subspace related to the category 220 (e.g., “Current European Royalty”) that includes the document segment 252 (e.g., about “British Queen Elizabeth”). In a particular aspect, the search engine 112 generates the model 137 to give more preference to the second keyword-related subspace that is related to the particular keywords (e.g., “European” and “Royalty”) that are semantically similar to the one or more keywords 111 (e.g., “British” and “Queen”) and include the document segment 256. In a particular example, the search engine 112 generates the model 137 to give more preference to the first keyword-independent subspace (e.g., related to a trending topic) that indicates the one or more exploratory document segments 129A including the document segment 266 (e.g., about “Covid-19 Vaccine”).

In a particular aspect, the search engine 112 generates the model 137 to give less preference to document segments that match the non-relevant document segments of the search results 133. For example, the search engine 112 generates the model 137 to give less preference to document segments indicated in the subspace related to the category 222 (e.g., “Previous European Royalty”), the subspace related to the category 224 (e.g., “British Rock Bands”), or a combination thereof. In a particular aspect, the search engine 112 generates the model 137 to give less preference to the fourth keyword-related subspace that is related to particular keywords (e.g., “British” and “Rock Bands”) that are semantically similar to the one or more keywords 111 (e.g., “British” and “Queen”). In a particular example, the search engine 112 generates the model 1137 to give less preference to the second keyword-independent subspace (e.g., related to headers, etc.), the third keyword-independent subspace (e.g., related to greater than threshold punctuation marks), and the fourth keyword-independent subspace (e.g., related to less than threshold sentence length).

In a particular aspect, the search engine 112 uses various artificial neural network techniques (e.g., gradient descent, Newton's method, conjugate gradient, quasi-Newton method, Levenberg-Marquardt algorithm, or another training algorithm) to train the model 137. For example, the search engine 112 provides feature values of each document segment of the search results 133 as input to the model 137 to generate a model output indicating whether the document segment is predicted to be relevant to the search 117. The search engine 112 uses model training techniques (e.g., backpropagation techniques) to update (e.g., weights and biases of) the model 137 based on a comparison of the user input 135 indicating whether the document segment is relevant and the model output indicating whether the document segment is relevant. For example, the search engine 112 uses backpropagation techniques to update (e.g., weights and biases of) the model 137 such that subsequent model output is likely to be closer to subsequent values of the user input 135.

The search engine 112 associates the model 137 with the search 117. In a particular aspect, the user input 113, the user input 135, or both, indicate the search trigger 139 as described with reference to FIG. 1. The search engine 112 associates the search trigger 139 with the search 117 so that the model 137 can be used for a subsequent performance of the search 117 in response to detecting that the search trigger 139 is satisfied.

Referring to FIG. 4, a diagram illustrating aspects of a model-based document search is shown and generally designated 400. In a particular aspect, the model-based document search is performed by the search engine 112, the model 137, the one or more processors 104, the device 102, the system 100 of FIG. 1, or a combination thereof.

The search engine 112, in response to determining that the search trigger 139 is satisfied, performs the model-based document search by applying the model 137 to the set of documents 115, as described with reference to FIG. 1. In a particular implementation, the search engine 112 applies the model 137 to the representations of the set of documents 115 indicated by the feature space 240. In a particular aspect, one or more documents are removed or added to the set of documents 115 subsequent to a previous performance of the search 117 (e.g., the document search described with reference to FIG. 2), generation of the model 137, a previous update of the model 137, or a combination thereof, and prior to the model-based document search. For example, the set of documents 115 includes a document segment 452 including words (e.g., “British Queen Elizabeth”), a document segment 456 including words (e.g., “Prime Minister Sanna Marin”), a document segment 466 including words (e.g., “Covid-19 Vaccine”), one or more additional document segments, or a combination thereof. The representations of the additional document segments are added to the feature space 240 subsequent to a previous performance of the search 117 (e.g., the document search described with reference to FIG. 2), generation of the model 137, a previous update of the model 137, or a combination thereof, and prior to the model-based document search.

In a particular aspect, the search engine 112 applies the model 137 to the additional document segments added to the set of documents 115 (e.g., the representations of the additional document segments added to the feature space 240). For example, the search engine 112 provides feature values of each of the additional document segments as input to the model 137 to generate a model output indicating whether (or how much) the additional document segment is predicted to be relevant. The search engine 112 generates a model-based portion of the search results 141 indicating a particular document segment (e.g., the document segment 452, the document segment 456, the document segment 466, or a combination thereof) in response to determining that a model output of the model 137 for the particular document segment indicates that the particular document segment is predicted to be relevant (or relevant by at least a threshold amount).

In a particular implementation, the search engine 112 also generates a model-independent portion of the search results 141 by performing a model-independent document search, as described with reference to FIG. 2, on the additional document segments (e.g., the representations of the additional document segments). For example, the model-independent portion includes matching additional document segments, expanded additional document segments, related category additional document segments, exploratory additional document segments, or a combination thereof. In a particular aspect, the model-independent portion overlaps the model-based portion of the search results 141. For example, the model-based portion of the search results 141 includes model-based document segments 420 that overlap matching additional document segments 404, expanded additional document segments 406, and exploratory additional document segments 412 of the model-independent portion. In a particular aspect, the model-independent portion of the search results 141 includes at least one or more document segments that are not included in the model-based portion of the search results 141. For example, the model-based portion of the search results 141 is more focused on document segments that are likely to be relevant to the search 117.

Referring to FIG. 5, an example of the GUI 140 is shown. In a particular aspect, the GUI 130 is generated by the GUI generator 114, the one or more processors 104, the device 102, the system 100 of FIG. 1, or a combination thereof.

In a particular example, the GUI generator 114 generates the GUI 140 including a search title 510 indicating the one or more keywords 111 (e.g., “Queen” and “British”) and a results section 514 indicating the search results 141, and a submit option 518 to update the search 117. For example, the results section 514 indicates the model-based portion of the search results 141 (e.g., the document segment 452, the document segment 456, the document segment 466, one or more additional document segments, or a combination thereof). In a particular implementation, the results section 514 also indicates the model-independent portion of the search results 141 (described with reference to FIG. 4, not shown in FIG. 5).

In a particular aspect, the GUI 140 includes one or more checkboxes 516 that are selectable by the user 101 to indicate whether a corresponding document segment is relevant to the search 117. In a particular aspect, a selected checkbox indicates that a corresponding document segment is relevant to the search 117. Alternatively, an unselected checkbox indicates that a corresponding document segment is not relevant to the search 117. It should be understood that checkboxes are provided as an illustrative example of an input to indicate relevance or non-relevance of document segments. In other implementations, other types of inputs can be used to indicate various degrees of relevance.

In a particular aspect, the user 101 selects a checkbox 516A and a checkbox 516B to indicate that the document segment 452 (e.g., “Prince William and Kate are still going to visit the Queen.”) and the document segment 466 (e.g., “This is how effective a Covid-19 vaccine has to be for life . . . ”), respectively, are relevant to the search 117. The user 101 selects the submit option 518 to update the search 117 and the search engine 112, in response to the user selection of the submit option 518, receives a user input 145 indicating the user selections of the checkboxes 516.

The search engine 112 updates the model 137 based on the user input 145 in response to receiving the selection of the submit option 518. For example, the search engine 112 updates the model 137, as described with reference to FIG. 1, to give more preference to document segments that match the document segment 452 (e.g., “Prince William and Kate are still going to visit the Queen.”) and the document segment 266 (e.g., “This is how effective a Covid-19 vaccine has to be for life . . . ”), and less preference to the document segment 456 (e.g., “Prime Minister Sanna Marin told members of the media . . . ”). Updating the model 137 based on the user input 145 enables dynamically changing the model 137 based on changing preferences of the user 101, changing relevance of topics in the domain of the set of documents 115, or both.

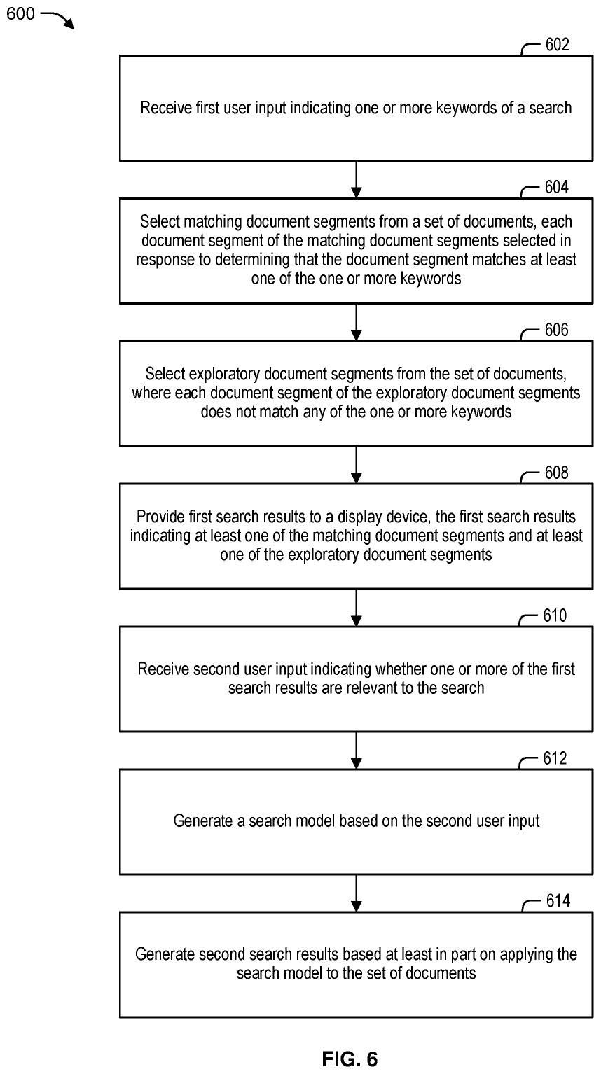

Referring to FIG. 6, a method 600 of performing a model-based search is shown. In a particular aspect, the method 600 is performed by one or more components described with respect to FIGS. 1-5.

The method 600 includes receiving first user input indicating one or more keywords of a search, at 602. For example, the search engine 112 of FIG. 1 receives the user input 113 indicating the one or more keywords 111 of the search 117, as described with reference to FIG. 1.

The method 600 also includes selecting matching document segments from a set of documents, at 604. For example, the search engine 112 of FIG. 1 selects the one or more matching document segments 121 from the set of documents 115, as described with reference to FIGS. 1-2. Each document segment of the one or more matching document segments 121 is selected in response to determining that the document segment matches at least one of the one or more keywords 111.

The method 600 further includes selecting exploratory document segments from the set of documents, at 606. For example, the search engine 112 of FIG. 1 selects the one or more exploratory document segments 129, such as the one or more exploratory document segments 129A, the one or more exploratory document segments 129B, the one or more exploratory document segments 129C, the one or more exploratory document segments 129D, or any combination thereof, as described with reference to FIGS. 1-2. Each document segment of the exploratory document segments 129 does not match any of the one or more keywords 111.

The method 600 also includes providing first search results to a display device, at 608. For example, the search engine 112 of FIG. 1 provides the GUI 130 indicating the search results 133 to the display device 108, as described with reference to FIGS. 1-3. In a particular aspect, the search results 133 indicate at least one of the one or more matching document segments 121 and at least one of the one or more exploratory document segments 129.

The method 600 further includes receiving second user input indicating whether one or more of the first search results are relevant to the search, at 610. For example, the search engine 112 of FIG. 1 receives the user input 135 indicating whether one or more of the search results 133 are relevant to the search 117, as described with reference to FIGS. 1 and 3.

The method 600 also includes generating a search model based on the second user input, at 612. For example, the search engine 112 of FIG. 1 generates the model 137 based on the user input 135, as described with reference to FIGS. 1 and 3.

The method 600 further includes generating second search results based at least in part on applying the search model to the set of documents, at 614. For example, the search engine 112 of FIG. 1 generates the search results 141 based at least in part on applying the model 137 to the set of documents 115, as described with reference to FIGS. 1 and 4.

The method 600 thus enables training of the model 137 to identify document segments that are relevant to the user 101. Generating the model 137 at least partially based on relevant document segments that are identified independently of the one or more keywords 111 enables the model 137 to generate search results that provide a wide coverage of relevant documents.

The systems and methods illustrated herein may be described in terms of functional block components, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as, but not limited to, C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may take the form of or include a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Systems and methods may be described herein with reference to block diagrams and flowchart illustrations of methods, apparatuses (e.g., systems), and computer media according to various aspects. It will be understood that each functional block of a block diagrams and flowchart illustration, and combinations of functional blocks in block diagrams and flowchart illustrations, respectively, can be implemented by computer program instructions.

Computer program instructions may be loaded onto a computer or other programmable data processing apparatus to produce a machine, such that the instructions that execute on the computer or other programmable data processing apparatus create means for implementing the functions specified in the flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

1. A device comprising:
a processor configured to:
receive first user input indicating one or more keywords of a search;
select matching document segments from a set of documents, each document segment of the matching document segments selected in response to determining that the document segment matches at least one of the one or more keywords;
select exploratory document segments from the set of documents, wherein each document segment of the exploratory document segments does not match any of the one or more keywords, wherein the exploratory document segments are distinct from the matching document segments;
provide first search results to a display device, the first search results indicating at least one of the matching document segments and at least one of the exploratory document segments;
receive second user input indicating whether one or more of the first search results are relevant to the search;
generate a search model based on the second user input; and
generate second search results based at least in part on applying the search model to the set of documents.

2. The device of claim 1, wherein the processor is configured to select expanded document segments from the set of documents, each document segment of the expanded document segments selected in response to determining that the document segment matches at least one or more second keywords, wherein the one or more second keywords are semantically similar to the one or more keywords, and wherein the first search results indicate the expanded document segments, wherein the expanded document segments are distinct from the exploratory document segments and are distinct from the matching document segments, and wherein the exploratory document segments are selected independent of the one or more second keywords.

3. The device of claim 1, wherein the processor is configured to, in response to determining that the matching document segments are included in one or more first categories, select related category document segments from the set of documents, wherein each of the related category document segments includes content associated with one or more second categories, and wherein each of the one or more second categories is related to at least one of the one or more first categories.

4. The device of claim 1, wherein the processor is configured to select the exploratory document segments in response to determining that a correlation among the exploratory document segments is greater than a threshold.

5. The device of claim 1, wherein the processor is configured to select a subset of the exploratory document segments in response to determining that each document segment of the subset is semantically identical to other document segments of the subset.

6. The device of claim 1, wherein the processor is configured to select a subset of the exploratory document segments in response to determining that each document segment of the subset includes an average count of punctuation marks per sentence that is greater than a punctuation threshold.

7. The device of claim 1, wherein the processor is configured to select a subset of the exploratory document segments in response to determining that each document segment of the subset includes an average sentence length that is less than a length threshold.

8. The device of claim 1, wherein the processor is configured to, in response to determining that the second user input indicates that a first subset of the first search results is relevant to the search, generate the search model to give more preference, in a subsequent performance of the search, to particular document segments that match the first subset.

9. The device of claim 1, wherein the processor is configured to, in response to determining that the second user input indicates that a second subset of the first search results is not relevant to the search, generate the search model to give less preference, in a subsequent performance of the search, to particular document segments that match the second subset.

10. The device of claim 1, wherein a first matching document segment of the matching document segments corresponds to a first document of the set of documents, wherein a first exploratory document segment of the exploratory document segments corresponds to a second document, and wherein the first document is distinct from the second document.

11. A method comprising:
receiving, at a device, first user input indicating one or more keywords of a search;
selecting, at the device, matching document segments from a set of documents, each document segment of the matching document segments selected in response to determining that the document segment matches at least one of the one or more keywords;
selecting, at the device, exploratory document segments from the set of documents, wherein each document segment of the exploratory document segments does not match any of the one or more keywords, wherein the exploratory document segments are distinct from the matching document segments;
providing, at the device, first search results to a display device, the first search results indicating at least one of the matching document segments and at least one of the exploratory document segments;
receiving, at the device, second user input indicating whether one or more of the first search results are relevant to the search;
generating, at the device, a search model based on the second user input; and
generating, at the device, second search results based at least in part on applying the search model to the set of documents.

12. The method of claim 11, wherein one or more additional documents are added to the set of documents subsequent to generating the search model and prior to generating the second search results.

13. The method of claim 12, wherein the second search results include at least one document segment of the one or more additional documents.

14. The method of claim 11, wherein the second search results are generated in response to determining that a search trigger is satisfied.

15. The method of claim 14, further comprising determining that the search trigger is satisfied in response to detecting that at least a threshold count of documents have been added to the set of documents subsequent to a previous performance of the search, that a particular time has elapsed since the previous performance of the search, that a request is received to perform the search, or a combination thereof.

16. The method of claim 11, further comprising selecting second matching document segments from the set of documents, each document segment of the second matching document segments selected in response to determining that the document segment matches at least one of the one or more keywords, wherein the second search results include the second matching document segments.

17. The method of claim 16, further comprising, in response to determining that the second matching document segments are included in one or more first categories, selecting related category document segments from the set of documents, wherein each of the related category document segments includes content associated with one or more second categories, and wherein each of the second categories is related to at least one of the one or more first categories.

18. The method of claim 11, further comprising selecting second expanded document segments from the set of documents, each document segment of the second expanded document segments selected in response to determining that the document segment matches at least one or more particular keywords, wherein the one or more particular keywords are semantically similar to the one or more keywords, and wherein the second search results indicate the second expanded document segments.

19. The method of claim 11, further comprising selecting second exploratory document segments from the set of documents in response to determining that a correlation among the second exploratory document segments is greater than a threshold, each document segment of the second exploratory document segments does not match any of the one or more keywords, wherein the second search results include the second exploratory document segments.

20. A computer-readable storage device storing instructions that, when executed by one or more processors, cause the processors to:
receive first user input indicating one or more keywords of a search;
select matching document segments from a set of documents, each document segment of the matching document segments selected in response to determining that the document segment matches at least one of the one or more keywords;
select exploratory document segments from the set of documents, wherein each document segment of the exploratory document segments does not match any of the one or more keywords, wherein the exploratory document segments are distinct from the matching document segments;
provide first search results to a display device, the first search results indicating at least one of the matching document segments and at least one of the exploratory document segments;
receive second user input indicating whether one or more of the first search results are relevant to the search;
generate a search model based on the second user input; and
generate second search results based at least in part on applying the search model to the set of documents.

21. The computer-readable storage device of claim 20, wherein the instructions, when executed by the processor, further cause the processor to:
receive particular user input indicating whether one or more of the second search results are relevant; and
update the search model based on the particular user input.
